(19) United States
(12) Patent Application Publication
(10) Pub. No.: US 2025/0372794 A1
(43) Pub. Date: Dec. 4, 2025

(54) VEHICLE POWER STORAGE DEVICE

(71) Applicant: TOYOTA JIDOSHA KABUSHIKI KAISHA, Toyota-shi (JP)

(72) Inventor: Takuya MORIOKI, Nagoya-shi (JP)

(73) Assignee: TOYOTA JIDOSHA KABUSHIKI KAISHA, Toyota-shi (JP)

(21) Appl. No.: 19/095,390

(22) Filed: Mar. 31, 2025

(30) Foreign Application Priority Data
May 29, 2024 (JP) 2024-087479

(51) Int. Cl. H01M 50/262; B60L 50/64; H01M 50/204; H01M 50/249

(52) U.S. Cl. CPC H01M 50/262; B60L 50/64; H01M 50/204; H01M 50/249; H01M 2220/20

(57) ABSTRACT

The vehicle power storage device includes a beam member extending in one direction, a battery module disposed on both sides of the beam member across the beam member, a first bracket that connects the battery module disposed on one side of the beam member and the beam member, and a second bracket that connects the battery module disposed on the other side of the beam member and the beam member, wherein the first bracket and the second bracket are opposed to each other in a direction intersecting the one direction, and include a load transmission portion disposed at an interval along the one direction.

### CROSS-REFERENCE TO RELATED APPLICATION

This application claims priority to Japanese Patent Application No. 2024-087479 filed on May 29, 2024. The disclosure of the above-identified application, including the specification, drawings, and claims, is incorporated by reference herein in its entirety.

### BACKGROUND

### 1. Technical Field

The present disclosure relates to a vehicle power storage device.

### 2. Description of Related Art

Japanese Unexamined Patent Application Publication No. 2020-064815 (JP 2020-064815 A) discloses a power storage device in which a plurality of power storage units (battery modules) is disposed in a battery case. Further, in the power storage device that is disclosed in JP 2020-064815 A, a plurality of beam members is disposed in the battery case, and the power storage unit is fastened by bolting to the beam members via a plurality of second members that is provided in the power storage unit.

### SUMMARY

However, in the structure that is disclosed in JP 2020-064815 A above, the second members are strewn across a side wall of the power storage unit, and accordingly there is a possibility that a load that is input to the second members in an event of a collision or the like of a vehicle will not be transmitted, with the stress being concentrated on the second members.

In view of the above circumstances, it is an object of the present disclosure to provide a vehicle power storage device that is capable of, in a configuration including a plurality of battery modules, maintaining a satisfactory attachment state of the battery modules.

A vehicle power storage device according to a first aspect includes
a beam member that extends in one direction,
battery modules that are disposed on both sides of the beam member, across the beam member,
a first bracket that links the battery module that is disposed on one side of the beam member with the beam member, and
a second bracket that links the battery module that is disposed on another side of the beam member with the beam member, in which
the first bracket and the second bracket are disposed so as to face each other in a direction intersecting the one direction, and also include load transmission portions that are disposed at intervals along the one direction.

In the vehicle power storage device according to the first aspect, the battery modules are disposed on both sides of the beam member, across the beam member. Also, the battery module that is disposed on one side of the beam member and the beam member are linked by the first bracket, and the battery module that is disposed on the other side of the beam member and the beam member are linked by the second bracket. Also, the first bracket and the second bracket are disposed so as to face each other in a direction intersecting the one direction. Further, the first bracket and the second bracket include the load transmission portions that are disposed at intervals along the one direction. Accordingly, even when a collision load is input in one direction in the event of a collision of the vehicle, the load transmission portion of the first bracket and the load transmission portion of the second bracket come into contact with each other, and thus the collision load can be distributed to and borne by the two brackets. As a result, the brackets can be suppressed from coming loose from the beam member.

According to a second aspect, in the vehicle power storage device according to the first aspect,
the first bracket includes a first base portion extending in the one direction,
the second bracket includes a second base portion extending in the one direction, and
the load transmission portions are configured including a first load transmission portion protruding from the first base portion toward a side of the second bracket, and a second load transmission portion protruding from the second base portion toward a side of the first bracket.

In the vehicle power storage device according to the second aspect, the first bracket includes the first base portion extending in the one direction and the first load transmission portion protruding from this first base portion toward the second bracket side. Also, the second bracket includes the second base portion extending in the one direction and the second load transmission portion protruding from this second base portion toward the first bracket side. Accordingly, when a collision load or the like is input in one direction and the first load transmission portion and the second load transmission portion come into contact with each other, the collision load can be transmitted to the side opposite to the collision side, via the first base portion and the second base.

According to a third aspect, in the vehicle power storage device according to the second aspect,
a fastener for fastening the first bracket to the beam member is attached to the first load transmission portion,
a fastener for fastening the second bracket to the beam member is attached to the second load transmission portion, and the fasteners are disposed along the one direction.

In the vehicle power storage device according to the third aspect, the first bracket is fastened to the beam member by the fastener that is attached to the first load transmission portion, and the second bracket is fastened to the beam member by the fastener that is attached to the second load transmission portion. Now, the fasteners are disposed along one direction, and accordingly when a collision load or the like is input to the first load transmission portion and the second load transmission portion, the collision load can be distributed to the first bracket, the second bracket, and the beam member, via the fasteners.

According to a fourth aspect, in the vehicle power storage device according to the second or third aspect, a plurality of the first load transmission portion, and a plurality of the second load transmission portion, are fashioned at intervals along the one direction, and are also disposed adjacent to each other in a staggered manner.

In the vehicle power storage device according to the fourth aspect, the first load transmission portions and the second load transmission portions are disposed adjacent to each other in a staggered manner, and accordingly the first load transmission portions and the second load transmission portions can be brought into contact with each other immediately after the collision load is input.

According to a fifth aspect, in the vehicle power storage device according to the fourth aspect,
the beam member, the first bracket, and the second bracket extend in a vehicle width direction,
the first bracket includes a protruding portion that protrudes further to an outward side in the vehicle width direction than the battery modules, and
an amount of protrusion of the protruding portion with respect to the battery modules is set to a dimension that is greater than a gap in the vehicle width direction between the first load transmission portions and the second load transmission portions.

In the vehicle power storage device according to the fifth aspect, the beam member, the first bracket, and the second bracket extend in the vehicle width direction, and accordingly the collision load can be dispersed in the event of a broadside collision of the vehicle. In addition, the amount of protrusion of the protruding portion with respect to the battery modules is set to a dimension that is greater than the gap in the vehicle width direction between the first load transmission portions and the second load transmission portions, and accordingly the first load transmission portions and the second load transmission portions can be brought into contact with each other before a colliding object collides with the battery modules, and thus the collision load can be borne at an early stage.

As described above, according to the vehicle power storage device of the present disclosure, in the configuration including multiple battery modules, the attachment state of the battery modules can be maintained satisfactorily.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a main part of a vehicle including a vehicle power storage device according to an embodiment;

FIG. 2 is an exploded perspective view illustrating a vehicle power storage device according to the embodiment;

FIG. 3 is a cross-sectional view taken along line 3-3 of FIG. 2;

FIG. 4 is a plan view of a vehicle power storage device according to the embodiment;

FIG. 5 is an enlarged view of a main part of FIG. 4;

FIG. 6 is an enlarged view of a main part corresponding to FIG. 5, showing the brackets in the first modification; and

FIG. 7 is an enlarged view of a main part corresponding to FIG. 5, showing the bracket in the second modification.

### DETAILED DESCRIPTION OF EMBODIMENTS

A vehicle power storage device 10 according to an embodiment will be described with reference to the drawings. Note that the arrows UP, the arrow FR, and the arrow RH shown in the drawings indicate the upward direction in the vehicle up-down direction, the forward direction in the vehicle front-rear direction, and the rightward direction in the vehicle left-right direction (vehicle widthwise direction) in the vehicle V on which the vehicle power storage device 10 is mounted, respectively. Further, in the following description, when the vertical, front-rear, and left-right directions are simply used, the vertical direction of the vehicle front-rear direction, the vertical direction of the vehicle up-down direction, and the horizontal direction of the vehicle (the vehicle width direction) are indicated, respectively, unless otherwise specified.

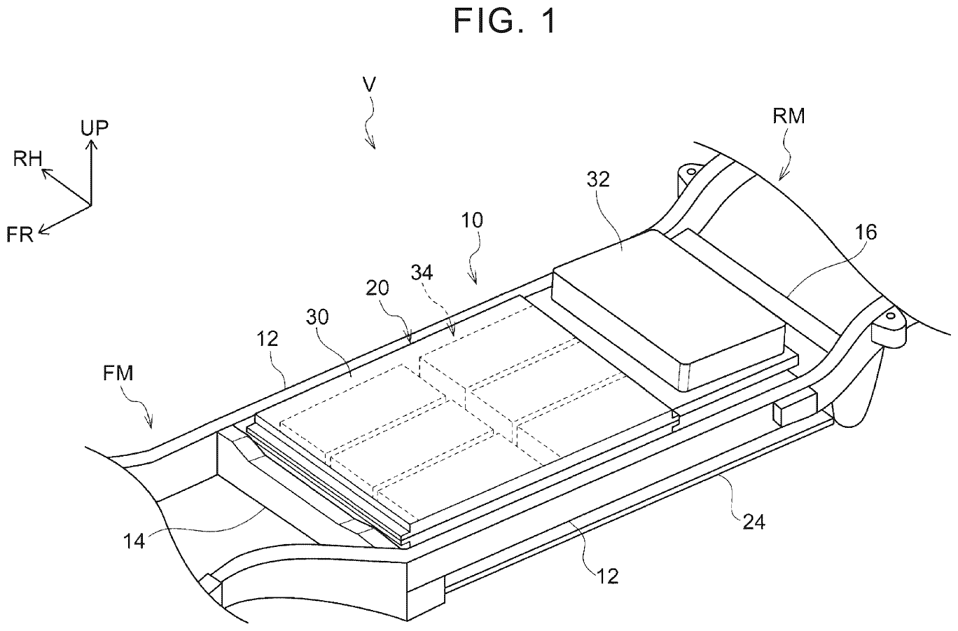

FIG. 1 is a perspective view showing a main part of a vehicle V including a vehicle power storage device 10 according to an embodiment. As shown in FIG. 1, a pair of left and right rockers 12 is provided at a center portion of the vehicle V in the vehicle front-rear direction. Each of the rockers 12 extends in the vehicle front-rear direction and constitutes a skeleton member having a closed cross-sectional structure.

The front end of the rocker 12 is connected by a front cross member 14 extending in the vehicle width direction. The rear end portion of the rocker 12 is connected by a rear cross member 16 extending in the vehicle width direction. Therefore, the center portion of the vehicle V in the front-rear direction is formed into a substantially rectangular frame shape in plan view by the rocker 12, the front cross member 14, and the rear cross member 16.

A front module FM constituting a power unit room is provided on a vehicle front side of the rocker 12, and a rear module RM constituting a rear portion of the vehicle V is provided on a vehicle rear side of the rocker 12. Detailed explanation of the front module FM and the rear module RM is omitted. The front module FM and the rear module RM may be formed by welding a plurality of skeleton members, or a part of the skeleton may be integrally formed by casting or the like.

Here, the vehicle power storage device 10 is provided in the frame of the frame formed by the rocker 12, the front cross member 14, and the rear cross member 16. The vehicle power storage device 10 is configured to be capable of storing electric power for supplying electric power to a motor that is a driving source of the vehicle V. Note that the vehicles V of the present embodiment are battery electric vehicle (BEV: Battery Electric Vehicle), fuel cell electric vehicle (FCEV: Fuel Cell Electric Vehicle), hybrid electric vehicle (HEV: Hybrid Electric Vehicle), plug-in hybrid electric vehicle (PHEV: Plug-in Hybrid Electric Vehicle) and the like that are driven by the power generated by the power unit.

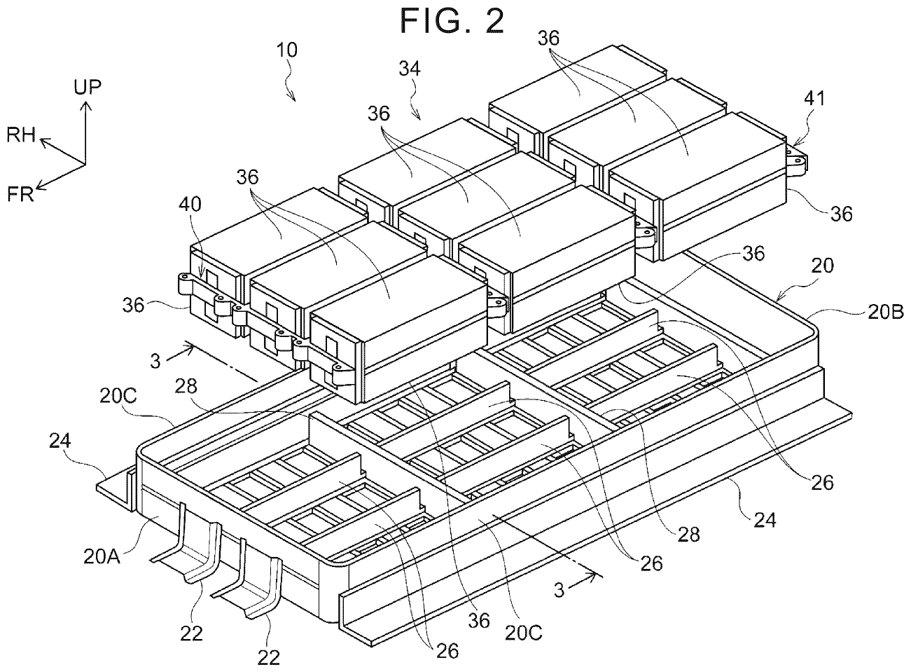

FIG. 2 is an exploded perspective view illustrating the vehicle power storage device 10 according to the embodiment. The vehicle power storage device 10 of the present embodiment includes, as an example, a battery case 20. The battery case 20 is formed in a substantially rectangular box shape in plan view. The battery case 20 includes a front wall portion 20A that extends in the vehicle width direction in the vehicle front, a rear wall portion 20B that extends in the vehicle width direction in the vehicle rear, and a pair of side wall portions 20C that connect both end portions of the front wall portion 20A and the rear wall portion 20B to each other in the front-rear direction.

On the front surface of the front wall portion 20A, two cross-side brackets 22 are provided at intervals in the vehicle width direction. Each of the cross-side brackets 22 is formed in a substantially L-shape when viewed in the vehicle widthwise direction, and a part extending in the vehicle vertical direction is fixed to the front wall portion 20A. Further, a portion of the cross-side bracket 22 extending in the vehicle front-rear direction is fixed to the lower surface of the front cross member 14 (see FIG. 1).

A rocker-side bracket 24 is provided on the side wall portion 20C of the battery case 20. The rocker-side bracket 24 is formed to have a length substantially equal to that of the side wall portion 20C and extends in the vehicle front-rear direction, and is formed in a substantially L-shape when viewed from the vehicle front-rear direction. The upper and lower portions of the rocker-side brackets 24 are fixed to the side wall portion 20C. Further, a portion of the rocker-side bracket 24 extending in the vehicle width direction is fixed to the lower surface of the rocker 12 (see FIG. 1).

Here, the bottom wall of the battery case 20 is provided with a plurality of longitudinal reinforcements 26 extending in the vehicle front-rear direction and a plurality of lateral reinforcements 28 as beam members extending in the vehicle width direction (one direction).

Two longitudinal reinforcements 26 are provided at a front portion of the battery case 20 at intervals in the vehicle width direction, and two longitudinal reinforcements are provided at intervals in the vehicle width direction at a rear portion of the battery case 20. In addition, two longitudinal reinforcements 26 are also provided in the center portion of the battery case 20 in the vehicle front-rear direction at intervals in the vehicle width direction.

The lateral reinforcement 28 is provided at a position where the battery case 20 is divided into three equal parts in the vehicle front-rear direction. Specifically, the lateral reinforcement 28 disposed on the front side is provided between the longitudinal reinforcement 26 of the front portion and the longitudinal reinforcement 26 of the central portion. Further, the lateral reinforcement 28 disposed on the rear side is provided between the longitudinal reinforcement 26 in the central portion and the longitudinal reinforcement 26 in the rear portion. Furthermore, each of the two horizontal reinforcements 28 is formed to have a length in the vehicle vertical direction longer than that of the longitudinal reinforcement 26.

As shown in FIG. 1, the battery case 20 includes a cover 30, and the battery pack 34 is accommodated in the battery case 20. In addition, devices 32 are provided on the upper surface of the cover 30 at the rear portion of the battery case 20. The devices 32 include, for example, ECU (Electronic Control Unit), BMS (Battery Management System), JB (Junction Box), and the like.

As shown in FIG. 2, the battery pack 34 includes a plurality of battery modules 36, and in the present embodiment, as an example, the battery pack 34 includes 18 battery modules 36. Each of the battery modules 36 is modularized in a state in which a plurality of cells are stacked.

Six battery modules 36 are accommodated in an area surrounded by the front wall portion 20A, the front side lateral reinforcement 28, and the side wall portion 20C of the battery case 20. Six battery modules 36 are accommodated in an area surrounded by the front and rear lateral reinforcements 28 and the side wall portion 20C. Further, six battery modules 36 are accommodated in an area surrounded by the rear wall portion 20B, the rear lateral reinforcement 28, and the side wall portion 20C. As described above, the battery modules 36 are disposed on both front and rear sides of the lateral reinforcement 28 with the lateral reinforcement 28 interposed therebetween.

Here, the plurality of battery modules 36 are connected in the vehicle width direction by the front-side mounting bracket 40 and the rear-side mounting bracket 41. The front-side mounting bracket 40 is attached to the front end of the battery module 36, and the rear-side mounting bracket 41 is attached to the rear end of the battery module 36. The battery modules 36 arranged in the upper and lower directions are connected to each other by the front-side mounting bracket 40 and the rear-side mounting bracket 41. That is, six battery modules 36 are connected by the front-side mounting bracket 40 and the rear-side mounting bracket 41. Details of the front-side mounting bracket 40 and the rear-side mounting bracket 41 will be described later.

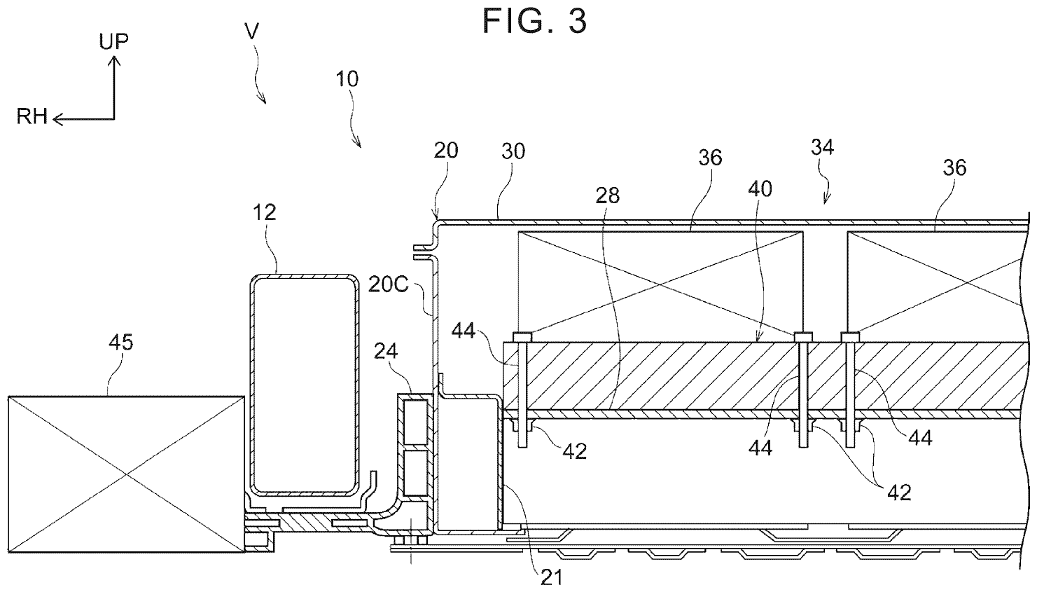

FIG. 3 is a cross-sectional view taken along line 3-3 of FIG. 2. As shown in FIG. 3, a reinforcing portion 21 having a substantially L-shaped cross section is provided inside the battery case 20. The reinforcing portion 21 extends in the vehicle front-rear direction and is joined to the bottom portion and the side wall portion 20C of the battery case 20. The bottom portion of the battery case 20, the side wall portion 20C, and the reinforcing portion 21 form a closed cross-section. Although only the reinforcing portion 21 on the right side of the vehicle is illustrated in FIG. 3, the same reinforcing portion is provided on the left side of the vehicle.

Here, the lateral reinforcement 28 is installed between the reinforcing portions 21. That is, the right end portion of the lateral reinforcement 28 is joined to the right reinforcing portion 21, and the left end portion of the lateral reinforcement 28 is joined to the left reinforcing portion 21.

A weld nut 42 is provided inside the lateral reinforcement 28, and a bolt 44 as a fastener is screwed to the weld nut 42. The bolt 44 is inserted into the front-side mounting bracket 40 from above the vehicle, passes through the front-side mounting bracket 40, and is screwed into the weld nut 42. In this way, the front-side mounting bracket 40 is fastened to the lateral reinforcement 28. Although not shown, the rear-side mounting bracket 41 is also fastened to the lateral reinforcement 28 by bolts and weld nuts.

The front-side mounting bracket 40 extends in the vehicle width direction, and the right end portion of the front-side mounting bracket 40 is located on the right side of the rightmost battery module 36. Further, although not shown, the left end of the front-side mounting bracket 40 is located on the left side of the leftmost battery module 36. Therefore, the front-side mounting bracket 40 has a structure protruding in the vehicle width direction from the battery pack 34.

An impact absorbing member 45 is disposed outside the rocker 12 in the vehicle width direction. The impact absorbing member 45 has a shape partitioned into a plurality of internal spaces so as to be deformed at the time of input of a collision load and to absorb a collision load, although a cross section is not shown. Further, the impact absorbing member 45 extends in the vehicle front-rear direction adjacent to the rocker 12, and the upper surface of the impact absorbing member 45 is set at a position higher than the lateral reinforcement 28. Therefore, when viewed from the vehicle width direction, the upper portion of the impact absorbing member 45 overlaps with the front-side mounting bracket 40.

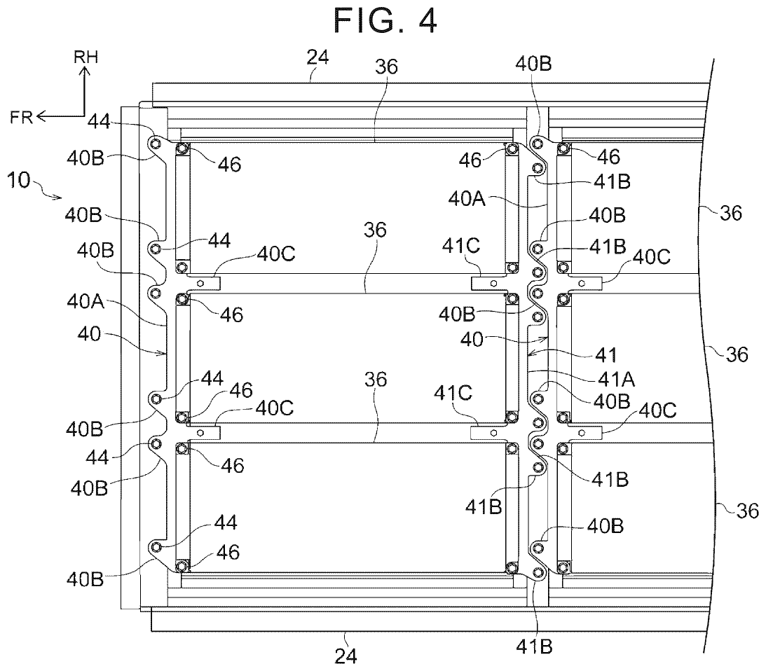

FIG. 4 is a plan view of the vehicle power storage device 10 according to the embodiment. As shown in FIG. 4, a front-side mounting bracket 40 is attached to the front end of the battery module 36, and a rear-side mounting bracket 41 is attached to the rear end of the battery module 36.

Here, in the battery module 36 adjacent to the lateral reinforcement 28 in the vehicle front-rear direction, the front-side mounting bracket 40 of the battery module 36 disposed on the rear side corresponds to the “first bracket” in the present disclosure. Further, the rear-side mounting bracket 41 of the battery module 36 disposed on the front side corresponds to the “second bracket” in the present disclosure. The front-side mounting bracket 40 and the rear-side mounting bracket 41 are formed in the same shape, and the rear-side mounting bracket 41 is formed by reversing the front-side mounting bracket 40 by 180 degrees in a plan view and attaching it to the battery module 36.

The front-side mounting bracket 40 includes a base portion 40A and a load transmission portion 40B, and the base portion 40A and the load transmission portion 40B correspond to the “first base portion” and the “first load transmission portion” in the present disclosure. Further, the rear-side mounting bracket 41 includes a base portion 41A and a load transmission portion 41B, and the base portion 41A and the load transmission portion 41B correspond to the “second base portion” and the “second load transmission portion” in the present disclosure.

The base portion 40A extends in the vehicle width direction, and a part of the base portion 40A enters between the upper and lower battery modules 36. A bolt 46 is inserted into a front corner portion of the upper battery module 36, and the upper battery module 36 is fastened to the front-side mounting brackets 40 by screwing the bolts 46 into the base portion 40A. The bolts 46 are also inserted into the rear corner portions of the upper battery module 36, and the upper battery module 36 is fastened to the rear-side mounting brackets 41 by screwing the bolts 46 into the base portion 41A.

In the battery module 36 disposed on the lower side, bolts (not shown) are inserted through four corners in the same manner as the battery module 36 on the upper side. In the battery module 36, the lower battery module 36 is fastened to the front-side mounting bracket 40 and the rear-side mounting bracket 41 by screwing bolts into the base portion 40A and the base portion 41A from below.

Further, the vertical fixing portion 40C protrudes from the base portion 40A of the front-side mounting brackets 40 toward between the neighboring battery modules 36. The vertical fixing portion 40C is provided between the battery module 36 on the right side and the battery module 36 on the center side, and between the battery module 36 on the left side and the battery module 36 on the center side, respectively, and extends from the base portion 40A toward the rear side of the vehicle. The vertical fixing portion 40C is fastened to the longitudinal reinforcement 26 by a bolt (not shown).

A vertical fixing portion 41C similar to the vertical fixing portion 40C is provided on the base portion 41A of the rear-side mounting bracket 41. The vertical fixing portion 41C is provided between the battery module 36 on the right side and the battery module 36 on the center side, and between the battery module 36 on the left side and the battery module 36 on the center side, respectively, and extends from the base portion 41A toward the front side of the vehicle. The vertical fixing portion 41C is fastened to the longitudinal reinforcement 26 by a bolt (not shown).

In this way, the lateral reinforcement 28 and the longitudinal reinforcement 26 are connected by the base portion 40A of the front-side mounting brackets 40. The lateral reinforcement 28 and the longitudinal reinforcement 26 are connected by the base portion 41A of the rear-side mounting brackets 41. As a result, the bottom portion of the battery case 20 is reinforced, and the strength against vibration from the road surface side can be improved.

Here, the front-side mounting bracket 40 is provided with a plurality of load transmission portions 40B protruding from the base portion 40A toward the rear-side mounting bracket 41. In this embodiment, as an exemplary, the front-side mounting brackets 40 are provided with six load transmission portion 40B. The load transmission portion 40B is disposed at intervals along the vehicle width direction, and in the present embodiment, the load transmission portion 40B is provided at a position corresponding to the corner of the battery module 36.

The rear-side mounting bracket 41 is provided with a plurality of load transmission portions 41B protruding from the base portion 41A toward the front-side mounting bracket 40. In the present embodiment as an exemplary, the rear-side mounting brackets 41 are provided with six load transmission portion 41B.

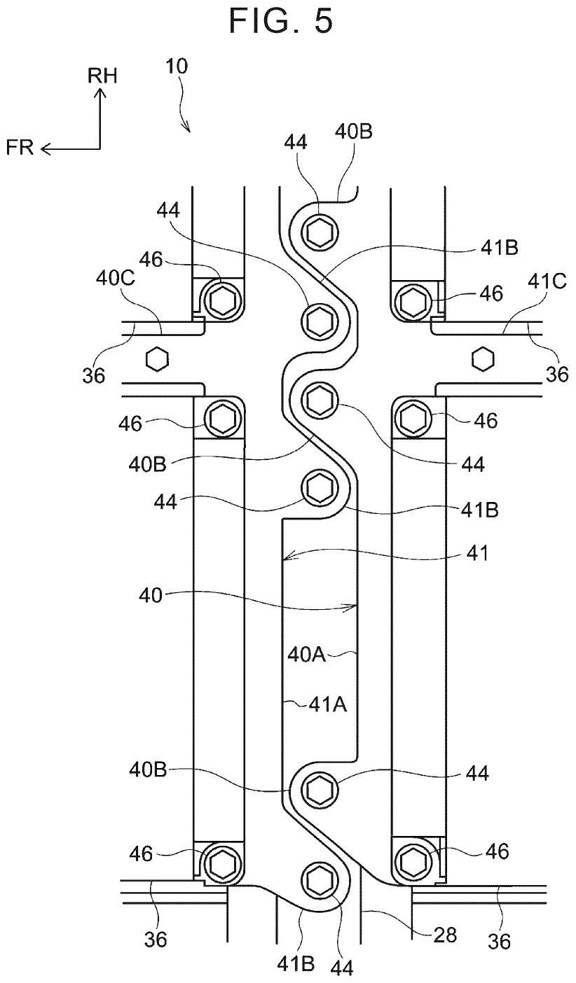

Hereinafter, the load transmission portion 40B and the load transmission portion 41B will be described in detail. FIG. 5 is an enlarged view of a main part of FIG. 4. As shown in FIG. 5, the load transmission portion 40B provided in the front-side mounting brackets 40 is formed in a substantially arc shape at the distal end thereof in a plan view. Further, the outer edge on the right side of the load transmission portion 40B extends in the vehicle front-rear direction, and the outer edge on the left side is inclined so as to be positioned on the right side from the vehicle rear side toward the vehicle front side. A distal end portion of the load transmission portion 40B is fastened to the lateral reinforcement 28 by a bolt 44.

The load transmission portion 41B provided in the rear-side mounting brackets 41 is formed in a substantially arcuate shape at a distal end thereof in a plan view. Further, an outer edge on the left side of the load transmission portion 41B extends in the vehicle front-rear direction, and an outer edge on the right side is inclined so as to be positioned on the left side from the vehicle front to the vehicle rear. A distal end portion of the load transmission portion 41B is fastened to the lateral reinforcement 28 by a bolt 44.

Here, the load transmission portion 40B of the front-side mounting bracket 40 and the load transmission portion 41B of the rear-side mounting bracket 41 are disposed adjacent to each other and alternately. Specifically, the load transmission portion 41B and the load transmission portion 40B are alternately arranged in this order from the left side.

Further, the outer edge on the left side of the load transmission portion 40B and the outer edge on the right side of the load transmission portion 41B are disposed close to each other, and are configured to be contacted by a surface when a load is inputted in the vehicle width direction.

Further, a bolt 44 for fastening the load transmission portion 40B and a bolt 44 for fastening the load transmission portion 41B are arranged substantially linearly along the vehicle width direction.

### Action

Next, the operation of the vehicle power storage device 10 according to the present embodiment will be described.

In the vehicle power storage device 10 according to the present embodiment, as shown in FIG. 2, the battery modules 36 are disposed on both front and rear sides of the lateral reinforcement 28, which is a beam member. Further, the battery module 36 disposed on one side of the lateral reinforcement 28 and the lateral reinforcement 28 are connected by a front-side mounting bracket 40 that is a first bracket. Further, the battery module 36 disposed on the other side of the lateral reinforcement 28 and the lateral reinforcement 28 are connected by a rear-side mounting bracket 41 which is a second bracket.

Here, as shown in FIG. 5, the front-side mounting bracket 40 and the rear-side mounting bracket 41 are disposed to face each other in the vehicle front-rear direction intersecting the vehicle width direction. Further, the front-side mounting bracket 40 and the rear-side mounting bracket 41 include load transmission portions 40B,41B disposed at intervals in the vehicle width direction. Accordingly, even when the collision load is inputted in the vehicle width direction at the time of collision of the vehicle V, the load transmission portion 40B of the front-side mounting bracket 40 and the load transmission portion 41B of the rear-side mounting bracket 41 come into contact with each other, so that the collision load can be distributed and borne by the two brackets. As a result, it is possible to prevent the battery module 36 from falling off the lateral reinforcement 28. As a result, the mounting state of the battery module 36 can be satisfactorily maintained in the configuration including the plurality of battery modules 36.

Further, in the present embodiment, the front-side mounting bracket 40 includes a base portion 40A extending in one direction and a load transmission portion 40B protruding from the base portion 40A toward the rear-side mounting bracket 41. Further, the rear-side mounting bracket 41 includes a base portion 41A extending in one direction and a load transmission portion 41B protruding from the base portion toward the front-side mounting bracket 40. Thus, when a collision load or the like is inputted in one direction and the load transmission portion 40B and the load transmission portion come into contact with each other, the collision load can be transmitted to the anti-collision side via the front-side mounting bracket 40 and the rear-side mounting bracket 41.

Further, in the present embodiment, the front-side mounting bracket 40 is fastened to the lateral reinforcement 28 by bolts 44 attached to the front-side mounting bracket 40. The rear-side mounting bracket 41 is fastened to the lateral reinforcement 28 by a bolt 44 attached to the rear-side mounting bracket 41. Here, the bolts 44 are arranged along the vehicle width direction in a plan view. Therefore, when a collision load or the like is inputted to the load transmission portion 40B and the load transmission portion 41B, the collision load can be distributed to the front-side mounting bracket 40, the rear-side mounting bracket 41, and the lateral reinforcement 28 members via the bolts 44.

Furthermore, in the present embodiment, the load transmission portion 40B of the front-side mounting bracket 40 and the load transmission portion 41B of the rear-side mounting bracket 41 are disposed close to each other and different from each other. Therefore, the load transmission portion 40B and the load transmission portion 41B can be brought into contact with each other immediately after the collision load is inputted.

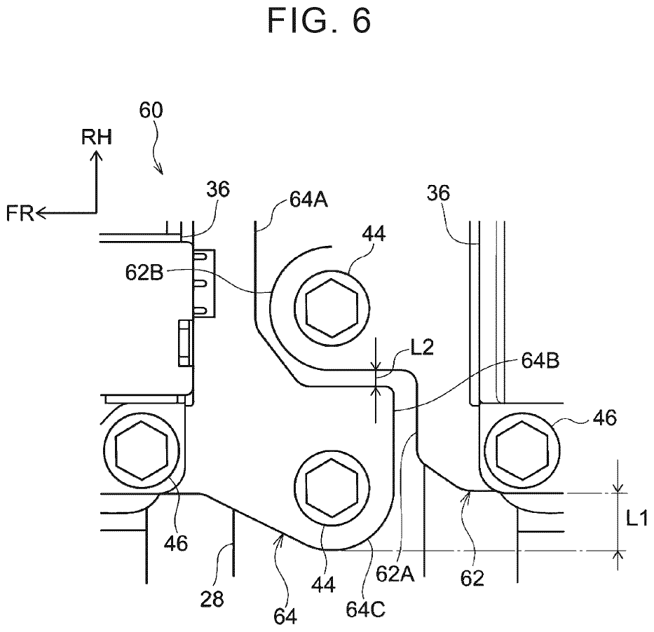

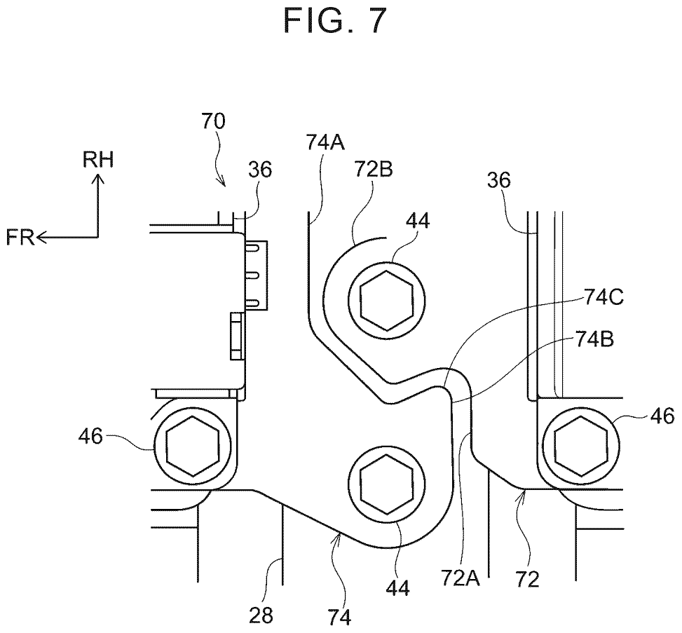

In the present embodiment, the inclined surface of the load transmission portion 40B and the inclined surface of the load transmission portion 41B are opposed to each other in the vehicle width direction. For example, the configuration of the modification shown in FIGS. 6 and 7 may be adopted.

### FIRST MODIFICATION

FIG. 6 is an enlarged view of a main part corresponding to FIG. 5, showing the bracket in the first modification. As shown in FIG. 6, the front-side mounting brackets 62 constituting the vehicle power storage device 60 of the present modification are configured to include a base portion 62A and a load transmission portion 62B. The base portion 62A and the load transmission portion 62B correspond to the “first base portion” and the “first load transmission portion” in the present disclosure. The rear-side mounting bracket 64 includes a base portion 64A and a load transmission portion 64B, and the base portion 64A and the load transmission portion 64B correspond to the “second base portion” and the “second load transmission portion” in the present disclosure.

Here, in the present modification, the shapes of the load transmission portion 62B and the load transmission portion 64B are different from those in the embodiment. Specifically, the load transmission portion 62B of the front-side mounting brackets 62 is formed in the same shape except for the rightmost load transmission portion 62B, and the right outer edge and the left outer edge extend in the front-rear direction of the vehicle. The load transmission portion 64B of the rear-side mounting brackets 64 is formed in the same shape as the load transmission portion 62B except for the leftmost load transmission portion 64B, and the left and right outer edges extend substantially parallel to the load transmission portion 62B in the vehicle front-rear direction.

Further, the load transmission portion 64B located on the leftmost side of the vehicle includes a protruding portion 64C. The protruding portion 64C protrudes to the left side of the vehicle with respect to the other load transmission portion 64B.

Here, the load transmission portion 64B, which is located on the leftmost side of the vehicle, protrudes to the left side of the battery module 36 from protruding amount L1, is set to be larger than the gap L2 between the load transmission portion 62B and the load transmission portion 64B in the vehicle widthwise direction.

In the present embodiment, the protruding amount L1 of the protruding portion 64C with respect to the battery module 36 is set to be larger than the gap L2 between the load transmission portion 62B and the load transmission portion 64B in the vehicle width direction. Therefore, the load transmission portion 62B and the load transmission portion 64B can be brought into contact with each other prior to the collision of the collision object with the battery module 36, and the collision load can be applied at an early stage.

### SECOND MODIFICATION

FIG. 7 is an enlarged view of a main part corresponding to FIG. 5, showing the bracket in the second modification. As shown in FIG. 7, the front-side mounting brackets 72 constituting the vehicle power storage device 70 of the present modification are configured to include a base portion 72A and a load transmission portion 72B. The base portion 72A and the load transmission portion 72B correspond to the “first base portion” and the “first load transmission portion” in the present disclosure. The rear-side mounting bracket 74 includes a base portion 74A and a load transmission portion 74B, and the base portion 74A and the load transmission portion 74B correspond to the “second base portion” and the “second load transmission portion” in the present disclosure.

Here, the load transmission portion 74B of the rear-side mounting brackets 74 in the present modification includes a wedge-shaped portion 74C. The load transmission portion 72B of the front-side mounting brackets 72 includes recesses recessed in a shape corresponding to the wedge-shaped portion 74C.

In the present modification, the wedge-shaped portion 74C of the load transmission portion 74B enters the recessed portion of the load transmission portion 72B at the time of the broadside collision of the vehicle, so that the collision load can be more effectively transmitted between the front-side mounting bracket 72 and the rear-side mounting bracket 74.

Although the vehicle power storage devices 10, 60, and 70 according to the embodiments and modifications have been described above, the present disclosure is not limited thereto and can be implemented in various forms without departing from the gist of the present disclosure. For example, in the above-described embodiment, as shown in FIG. 2, two battery modules 36 are vertically connected, but the present disclosure is not limited thereto. Further, although three battery modules 36 are connected to the left and right sides, the present disclosure is not limited thereto.

Further, in the above-described embodiment, as shown in FIG. 4, the front-side mounting bracket 40 and the rear-side mounting bracket 41 are each formed of one piece extending in the vehicle width direction, but the present disclosure is not limited thereto. For example, a plurality of components may be mechanically coupled to form a mounting bracket.

Further, in the above embodiment, the front-side mounting bracket 40 and the rear-side mounting bracket 41 are attached to the lateral reinforcement 28 extending in the vehicle width direction, but the present disclosure is not limited thereto. For example, a mounting bracket extending in the vehicle front-rear direction may be prepared, and the mounting bracket may be attached to the longitudinal reinforcement. In this case, the load transmission portions are arranged at intervals in the vehicle front-rear direction, and the load transmission portions come into contact with each other at the time of a front collision or a rear collision of the vehicle, thereby suppressing the battery module from falling off.

With respect to the above embodiments, the following supplementary notes are disclosed.

### APPENDIX 1

In a vehicle power storage device,
A beam member extending in one direction;
A battery module disposed on both sides of the beam member across the beam member,
A first bracket connecting the battery module and the beam member disposed on one side of the beam member,
A second bracket connecting the battery module and the beam member disposed on the other side of the beam member.

The first bracket and the second bracket are disposed to face each other in a direction intersecting the one direction, and include load transmission portions spaced at intervals in the one direction.

### APPENDIX 2

The first bracket includes a first base portion extending in the one direction. The second bracket includes a second base portion extending in the one direction. The load transmission portion includes a first load transmission portion protruding from the first base portion toward the second bracket side, and a second load transmission portion protruding from the second base portion toward the first bracket side.

### APPENDIX 3

In the vehicle power storage device described in Appendix 2, a fastener for fastening the first bracket to the beam member is attached to the first load transmission portion. A fastener for fastening the second bracket to the beam member is attached to the second load transmission portion. The fastener is disposed along the one direction.

### ADDITIONAL REMARK 4

In the vehicle power storage device according to Appendix 2 or 3, a plurality of the first load transmission portions and the second load transmission portions are formed at intervals along the one direction, and are arranged in close proximity and staggered.

### APPENDIX 5

In the vehicle power storage device according to any one of Appendices 2 to 4, the beam member, the first bracket, and the second bracket extend in the vehicle width direction. The first bracket includes a protruding portion protruding outward in the vehicle width direction from the battery module. The protruding amount of the protruding portion with respect to the battery module is set to be larger than a gap in the vehicle width direction between the first load transmission portion and the second load transmission portion.

What is claimed is:

1. A vehicle power storage device, comprising:
a beam member that extends in one direction;
battery modules that are disposed on both sides of the beam member, across the beam member;
a first bracket that links the battery module that is disposed on one side of the beam member with the beam member; and
a second bracket that links the battery module that is disposed on another side of the beam member with the beam member, wherein the first bracket and the second bracket are disposed so as to face each other in a direction intersecting the one direction, and also include load transmission portions that are disposed at intervals along the one direction.

2. The vehicle power storage device according to claim 1, wherein
the first bracket includes a first base portion extending in the one direction,
the second bracket includes a second base portion extending in the one direction, and
the load transmission portions are configured including a first load transmission portion protruding from the first base portion toward a side of the second bracket, and a second load transmission portion protruding from the second base portion toward a side of the first bracket.

3. The vehicle power storage device according to claim 2, wherein
a fastener for fastening the first bracket to the beam member is attached to the first load transmission portion,
a fastener for fastening the second bracket to the beam member is attached to the second load transmission portion, and
the fasteners are disposed along the one direction.

4. The vehicle power storage device according to claim 2, wherein a plurality of the first load transmission portion, and a plurality of the second load transmission portion, are fashioned at intervals along the one direction, and are also disposed adjacent to each other in a staggered manner.

5. The vehicle power storage device according to claim 4, wherein
the beam member, the first bracket, and the second bracket extend in a vehicle width direction,
the first bracket includes a protruding portion that protrudes further to an outward side in the vehicle width direction than the battery modules, and
an amount of protrusion of the protruding portion with respect to the battery modules is set to a dimension that is greater than a gap in the vehicle width direction between the first load transmission portions and the second load transmission portions.
